(19) United States
(12) Patent Application Publication
(10) Pub. No.: US 2026/0044517 A1
(43) Pub. Date: Feb. 12, 2026

(54) HEALTH INFORMATION NETWORK WELLNESS PLATFORM

(71) Applicant: Pfizer Inc., New York, NY (US)

(72) Inventors: Dennis HANCOCK, New Hope, PA (US); Katherine M. WIETMARSCHEN, Liberty Township, OH (US); Tim HOLT, Nashville, TN (US); John Gabriel OGHIA, Hoboken, NJ (US); Dorothy GEORGE, Los Angeles, CA (US); Steve HOFFMAN, Ardsley, NY (US); Steve GIPSTEIN, San Francisco, CA (US); Ian Thomas LYCKLAND, Saunderstown, RI (US); Daniele CODEGA, Brooklyn, NY (US); Ana Camila ENGELBERT, Larchmont, NY (US); Francesco BERTELLI, New York, NY (US); Andre CARDOZO, Berkeley, CA (US); Igor Oliveira, Los Angeles, CA (US); Allison Dougherty, New York, NY (US); Amina Abdeldaim, New York, NY (US); Jason O’Meara, New York, NY (US); Andrew Lewis, New York, NY (US); Renato Bonicio, New York, NY (US); Pedro Duarte, New York, NY (US); Jefferson Delfes, New York, NY (US); Jon Karlin, New York, NY (US); Aditya Agarwal, New York, NY (US)

(73) Assignee: Pfizer Inc., New York, NY (US)

(21) Appl. No.: 19/295,245

(22) Filed: Aug. 8, 2025

Related U.S. Application Data
(60) Provisional application No. 63/681,615, filed on Aug. 9, 2024.

(51) Int. Cl. G06F 16/2457; G06F 16/2453

(52) U.S. Cl. CPC G06F 16/24578; G06F 16/24539

(57) ABSTRACT

A system and method for personalizing health information content provided to a user. The techniques include obtaining user profile data associated with the user in response to a query submitted by the user. The user profile data includes health data of the user and application use data by the user. The techniques further include expanding the query into a plurality of queries based on the health data of the user, performing semantic searches for the plurality of queries, ranking results from the performed semantic searches, aggregating the results from the performed semantic searches based on the ranking to generate an aggregated health information response, and providing the aggregated health information response to the user.

### PRIORITY

The present application claims priority to U.S. Provisional Patent Application No. 63/681,615, titled HEALTH INFORMATION NETWORK WELLNESS PLATFORM, field Aug. 9, 2024, which is hereby incorporated by reference herein in its entirety.

### BACKGROUND

The experience of searching for answers about one's health and wellbeing can be overwhelming and frustrating for many individuals. In particular, searching across multiple websites can be challenging, and the information obtained is often fragmented, impersonal, unverified, and sometimes conflicting. Users may encounter difficulties in navigating through vast amounts of health-related content that varies widely in quality, accuracy, and relevance to their specific circumstances.

Traditional health information systems typically provide generic responses to user queries without considering individual health characteristics, demographics, medical histories, or personal circumstances. This approach may result in users receiving broad, generalized information that may not address their particular health profile or specific medical conditions. The lack of personalization in health information delivery can lead to responses that are less relevant or applicable to individual users' situations.

There exists a general need for curated, trusted, and credible sources for health information that can provide users with reliable and authoritative content. Many existing health information platforms may not adequately verify the accuracy of their content or may not draw from sufficiently authoritative medical sources. Users may struggle to distinguish between reliable health information and content that may be inaccurate, outdated, or misleading.

In addition to simply finding health information that individuals are searching for, it can be challenging to decide what to do with that information once it has been obtained. Users may receive health information but lack guidance on appropriate next steps, actionable recommendations, or direction on when to seck professional medical advice. The absence of clear guidance on how to apply health information to individual circumstances can limit the practical utility of the information provided.

Accordingly, there exists a general need for health information platforms that can provide actionable, relevant next steps to learn more, take action, or get help from experts when appropriate. Such platforms may benefit from incorporating sophisticated query processing techniques that can analyze user-specific health data and generate responses that are tailored to individual health profiles and circumstances. Enhanced personalization approaches may enable health information systems to provide more accurate, relevant, and comprehensive answers that address the specific needs and characteristics of individual users.

### SUMMARY

The present disclosure is directed to systems and methods for providing users access to health information.

In one embodiment, the present disclosure is directed to a computer-implemented method for personalizing health information content provided to a user, the method comprising: receiving, by a computer system, a query from the user, the query associated with health information; receiving, by the computer system, user profile data associated with the user, the user profile data comprising health data of the user and application use data by the user; expanding, by the computer system, the query into a plurality of queries based on the health data of the user; performing, by the computer system, semantic searches for the plurality of queries; ranking, by the computer system, results from the performed semantic searches; aggregating, by the computer system, the results from the performed semantic searches based on the ranking to generate an aggregated health information response; and providing, by the computer system, the aggregated health information response to the user.

In some embodiments, the method further includes determining, by the computer system, whether the query contains guardrail content; and based on whether the query contains the guardrail content, providing, by the computer system, a cached response to the query.

In some embodiments, the method further includes retrieving, by the computer system, source materials associated with the results from the performed semantic searches; and providing, by the computer system, citations to the retrieved source materials to the user in connection with the provided aggregated health information response.

In some embodiments, the method further includes verifying, by the computer system, the aggregated health information response based on the retrieved source materials; and providing, by the computer system, an indication as to whether the aggregated health information response is verified or unverified based on the verification.

In some embodiments, the aggregated health information response is provided via a large language model.

In some embodiments, the health data comprises biographic information and a medical history of the user.

In one embodiment, the present disclosure is directed to a computer system for personalizing health information content provided to a user, the computer system comprising: a processor; and a memory coupled to the processor, the memory storing instructions that, when executed by the processor, cause the computer system to: receive a query from the user, the query associated with health information; receive user profile data associated with the user, the user profile data comprising health data of the user and application use data by the user; expand the query into a plurality of queries based on the health data of the user; perform semantic searches for the plurality of queries; rank results from the performed semantic searches; aggregate the results from the performed semantic searches based on the ranking to generate an aggregated health information response; and provide the aggregated health information response to the user.

In some embodiments, the memory stores further instructions that, when executed by the processor, cause the computer system to: determine whether the query contains guardrail content; and based on whether the query contains the guardrail content, provide a cached response to the query.

In some embodiments, the memory stores further instructions that, when executed by the processor, cause the computer system to: retrieve source materials associated with the results from the performed semantic searches; and provide citations to the retrieved source materials to the user in connection with the provided aggregated health information response.

In some embodiments, the memory stores further instructions that, when executed by the processor, cause the computer system to: verify the aggregated health information response based on the retrieved source materials; and provide an indication as to whether the aggregated health information response is verified or unverified based on the verification.

In some embodiments, the aggregated health information response is provided via a large language model.

In some embodiments, the health data comprises biographic information and a medical history of the user.

### BRIEF DESCRIPTION OF THE FIGURES

The accompanying drawings are incorporated herein and form a part of the specification.

FIG. 1 depicts a diagram of a health information platform that can be accessed via users and communicate with third party systems, in accordance with an embodiment of the present disclosure.

FIG. 2 depicts a process for providing users personalized answers in a health information platform, in accordance with an embodiment of the present disclosure.

FIG. 3 depicts a process for utilizing a reasoning agent to generate targeted user responses, in accordance with an embodiment of the present disclosure.

### DETAILED DESCRIPTION

Example embodiments are provided so that this disclosure will be thorough and will fully convey the scope to those who are skilled in the art. Numerous specific details are set forth, such as examples of specific systems, components, devices, and methods, to provide a thorough understanding of embodiments of the present disclosure. It will be apparent to those skilled in the art that specific details need not be employed, that example embodiments can be embodied in many different forms and that neither should be construed to limit the scope of the disclosure. In some example embodiments, well-known processes, well-known device structures, and well-known technologies are not described in detail.

As shown and described more fully below, the instant disclosure includes systems, methods, and devices for providing users with content and other tools for obtaining information of various diseases or disorders (or symptoms associated therewith) and facilitating the ability for users to take actionable steps to address those diseases or disorders (e.g., by setting up an appointment with a healthcare provider, directing users to useful products relevant to the diseases or disorders, or providing users with the necessary information so that they can take actions themselves). The systems described herein can include computing components connected over one or more wired or wireless networks for storing health information and user data, personalizing the digital health information content to specific users, and transmitting health information content to users' computing devices (e.g., computers or smartphones). The methods described herein can include methods for administering health information to a user, methods for evaluating the performance of health information content based on user data and user-interaction therewith, and methods for personalizing the health information content based on the evaluation of the performance thereof. The devices described herein can include computing devices (e.g., server computer(s), smartphone(s), tablet(s), desktop computer(s), laptop computer(s), or any combination thereof) for storing, transmitting, personalizing, and/or executing a digital health management application. The user-facing digital health information application can constitute a website, a web application, a mobile application (i.e., an “app”), or any combination thereof.

The digital health information platform can provide health information content to users in the form of textual and/or audio/visual content delivered through a website accessed via a client (e.g., a web browser) executable on a computing device (e.g., a smartphone). The health information content can be provided from a host server or similar computing devices via a website, a web application, or an app downloaded by the user on his or her smartphone.

In some implementations, the digital health information platform can deliver non-therapeutic content to users. In such implementations, the digital health information platform can deliver health information content that is adapted to provide individuals with assistance in managing their diseases or conditions by either directly providing relevant information to users or directing users to appropriate healthcare professionals and/or products.

### Health Information Platform

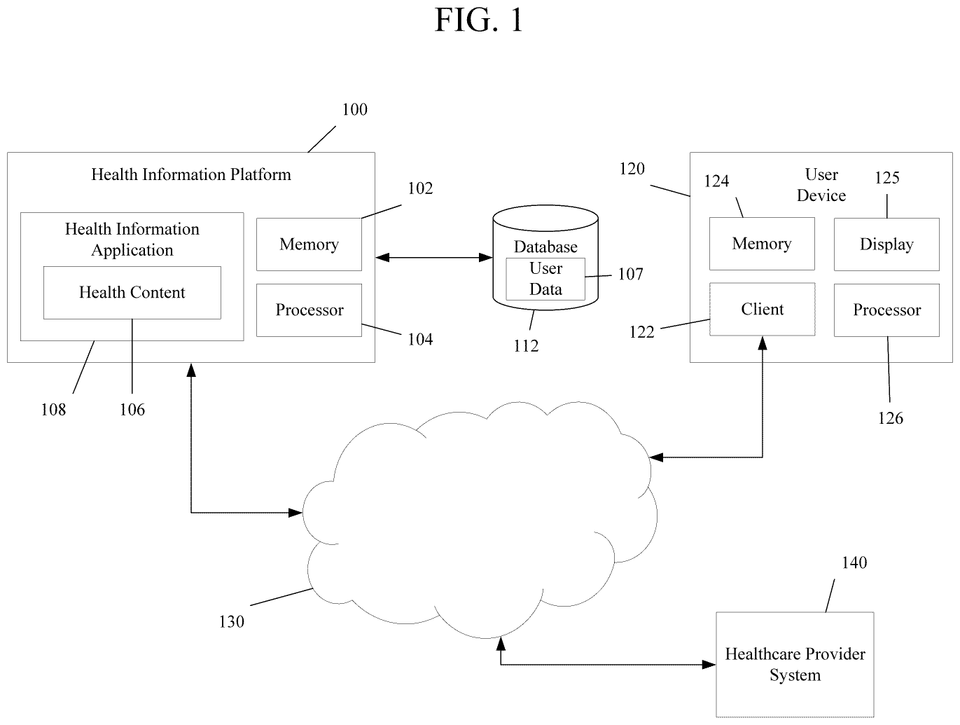

The present application is generally directed to the provision of health information to users. In one embodiment shown in FIG. 1, a health information platform 100 can be accessed via a user device 120 through a network 130 (e.g., the Internet or another telecommunication network). The health information platform 100 can provide content 106 to a user through the device 120. The health information platform 100 can include a computer system, such as a server or server system, that is configured to provide the content 106 to a user through the user device 120. The health information platform 100 can further include a memory 102 and a processor 104 that is adapted to execute instructions stored in the memory 102 to provide the content 106 to the user device 120 and perform other tasks described herein. The user device 120 can include a mobile device (e.g., a smartphone), a tablet, a laptop, a desktop computer, or any other device that is able to access and/or display the content 106. The content 106 of the health information platform 100 can be accessed via a client 122, such as a web browser or a smartphone app. In one illustrative embodiment, the client 122 can include a smartphone app downloaded by user on his or her user device 120. In other embodiments, the health information platform 100 can be accessed via, for example, a website, a web application, or as a software as a service (SaaS) model. The client 122 can provide a user interface through which the user can access, view, and/or interact with the digital therapy content 106 provided via the health information platform 100. In various embodiments, the client 122 can be downloaded via various digital distribution services, including app stores (e.g., the Google Play Store or the Apple App Store).

In some embodiments, the health information platform 100 can be embodied as one or more servers that are programmed to deliver content to the use via the client 122. In some embodiments, the health information platform 100 can be embodied as a cloud computing system. The cloud computing system can be a distributed system (e.g., remote environment) having scalable/elastic computing and storage resources. The cloud computing resources can execute the health information application 108 for facilitating communications with the user device 120 and storing data in the database 112. In some examples, the database 112 can reside on a standalone computing device. The health information application 108 can provide the user with the health content 106 that is delivered via the client 122 on the user device 120.

The database 112 can store, for example, user data 107. The user data 107 can include, for example, bibliographic data (e.g., name, age, or sex), health data (e.g., conditions or diseases that the user is suffering from, weight, or medical history), and/or application history data (e.g., prior queries that the user has performed or application usage data). In various embodiments, the user data 107 can be input by the user (e.g., as part of on onboarding process of creating an account with the health information platform 100) or retrieved from a healthcare provider system 140 (e.g., in the form of an electronic medical record). The user data 107 can be associated with a user account or profile that is associated with each individual use of the health information platform 100. The user profile can be retrieved or otherwise accessed by the health information application 108 in order to, for example, control the health content 106 provided to the user. In some embodiments, the user data 107 can be updated as the user interacts with the health information platform 100. For example, users can input bibliographic and/or health data as part of the account creation process or any time thereafter. As another example, the queries or other information that the user has submitted can be stored as user data 107.

The network 130 can include any type of network that allows sending and receiving communication signals, such as a wireless telecommunication network, a cellular telephone network, a time division multiple access (TDMA) network, a code division multiple access (CDMA) network, Global system for mobile communications (GSM), a third generation (3G) network, fourth generation (4G) network, fifth generation (5G) network, a satellite communications network, and other communication networks. The network 130 can include one or more of a Wide Area Network (WAN), a Local Area Network (LAN), and a Personal Area Network (PAN). In some examples, the network 130 includes a combination of data networks, telecommunication networks, and a combination of data and telecommunication networks. The user device 120 and the health information platform 100 can communicate with each other by sending and receiving signals (wired or wireless) via the network 130. In some examples, the network 130 provides access to cloud computing resources, which can include elastic/on-demand computing and/or storage resources available over the network 130.

The user device 120 can include, but is not limited to, a portable electronic device (e.g., smartphone, cellular phone, personal digital assistant, personal computer, or wireless tablet device), a desktop computer, or any other electronic device capable of sending and receiving information via the network 130. The user device 120 includes data processing hardware (e.g., a processor 126), memory 124, and a display 125 in communication with the data processing hardware. In some examples, the user device 120 includes a keyboard (either a physical or a software-based keyboard), mouse, microphones, and/or a camera for allowing the user to input data. In addition to or in lieu of the display 125, the user device 120 can include one or more speakers to output audio data to the user. For instance, the client 122 can be configured to provide audible alerts to the user or play audio content for the user. In some embodiments, the user device 120 can execute the client 122 that the user has downloaded and is stored in the memory 124 of the user device 120 to establish a connection with the health information platform 100 and access the digital health content 106. In other embodiments, the client 122 can include a web-based application through which the user can access the digital health content 106. In some embodiments, the user can have access to the health content 106 for a defined time period (e.g., 3 months). In some embodiments, the access to the health content 106 can be controlled based on whether the user has subscribed to the service provider controlling the health information platform 100. The client 122 when executed by the data processing hardware of the user device 120, can be configured to display a variety of graphical user interfaces (GUIs) on the display 125 that, among other things, allows the user to interact with the client 122.

In some embodiments, user devices 120 can access the health information platform 100 resources via a variety of different Infrastructure as a service (IaaS) standards, including, e.g., Amazon Elastic Compute Cloud (EC2), Open Cloud Computing Interface (OCCI), Cloud Infrastructure Management Interface (CIMI), or OpenStack standards. Some IaaS standards can allow clients access to resources over HTTP and can use Representational State Transfer (REST) protocol or Simple Object Access Protocol (SOAP). In some embodiments, user devices 120 can access the health information platform 100 resources via a variety of different Platform as a Service (PaaS) interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that can be built on REST, HTTP, XML, or other protocols. In some embodiments, user devices 120 can access health information platform 100 resources via a variety of different of web-based user interfaces (e.g., when the health information platform 100 is provided as a SaaS). In some embodiments, user devices 120 can also access SaaS resources through smartphone or tablet applications (e.g., Salesforce Sales Cloud or Google apps) or client operating systems.

In some embodiments, the health information platform 100 and/or the client 122 can further be configured to transmit and/or receive from a third-party system, such as a healthcare provider system 140. For example, the health information platform 100 and/or the client 122 can be configured to retrieve user medical information from a healthcare provider system 140 (e.g., in the form of an electronic medical record), provide notifications to the healthcare provider, and/or allow the user to book and manage appointments with the healthcare provider.

Additional detail regarding various embodiments of the health information platform can be found in U.S. patent application Ser. No. 18/754,913, titled HEALTH INFORMATION PLATFORM, filed Jun. 26, 2024, which is hereby incorporated by reference herein in its entireties.

### Response Personalization

Traditional health information systems may provide generic responses to user queries without considering individual health characteristics or personal medical backgrounds. The enhanced personalization approach described herein may address these limitations by implementing sophisticated query processing techniques that take into account user-specific health data. In some cases, the personalization process may involve transforming user profile information into formats that can be effectively utilized by natural language processing models and search algorithms.

The enhanced personalization methodology may incorporate reasoning agents 240 that analyze the relationship between user health profiles and submitted queries. These reasoning agents 240 may prioritize health profile characteristics that are most relevant to answering specific questions, generate analytical thoughts about how profile elements impact potential responses, and translate these insights into semantic search terms. The approach may enable health information platforms to provide more accurate, relevant, and comprehensive answers that are specifically tailored to individual users.

In some cases, the personalization process may involve multiple stages of query expansion and semantic searching. The system may generate multiple variations of an original query based on user health attributes, perform semantic searches for each expanded query, and aggregate results to create comprehensive personalized responses. The methodology may also incorporate verification processes to ensure the accuracy and reliability of personalized health information provided to users.

As described above, the health information platform 100 can make use of user profiles or accounts to store user data 107 individualized to each user. One beneficial aspect of storing such user data 107 is that it can be used to personalize the answers provided by the health information application 108 to a user's queries. Instead of providing generalized answers to queries, the health information platform 100 can provide answers that are tailored specifically to each user based on his or her bibliographic information, health information, medical history, and other information available to the health information platform 100.

In some aspects, the health information platform 100 can include or embody a system for processing natural language queries submitted by users and generating verified responses. This system can include several different components or modules that are executed by or included within the health information application 108, including those components that are described below. As used herein, the term “module” refers to hardware, software, firmware, or various combinations thereof that are operable to execute the described functions. In one embodiment, a module can be embodied as instructions stored in a memory that are executed by a processor (e.g., a microprocessor) coupled thereto. In another embodiment, a modules can be embodied as a field-programmable gate array (FPGA) or application-specific integrated circuit (ASIC).

The system can include a natural language spell checker module. This module can be responsible for ensuring the accuracy of the input query by correcting any spelling errors or typos. In some cases, the system can not include a spell checker module and the input query can be processed as it is received.

The system can include a fine-tuned natural language processing (NLP) module. This module can be responsible for understanding the context and semantics of the input query. In some cases, the system can use an open-source NLP model, while in other cases, a licensed or proprietary NLP model can be used.

The system can include a semantic search module. This module can be responsible for expanding the query with relevant health attributes and conducting multiple semantic searches. The results of these searches can then be re-ranked by a re-rank results module. In some cases, the system can use an open-source re-rank model, while in other cases, a licensed or proprietary re-rank model can be used.

The system can also include a module for returning relevant source documents. These documents can provide additional context or information related to the input query. In some cases, the system can also include a module for personalizing the responses based on the user's health profile attributes.

Finally, the system can include a module for verifying the responses generated by the system. This module can use a citation model to ensure the accuracy and reliability of the responses. In some cases, the system can mark the responses as verified or unverified based on the results of the citation model. In some embodiments, the system can also include a module for tracking and recalling previously submitted queries by the user so that the system can respond to follow-up questions within the proper context of the previously submitted queries. In some cases, the system can make use of past user-submitted questions, previously provided answers, and previously cited source documents in generating the responses to the user's follow-up questions.

In some embodiments, the system can stream the responses to the user. In other embodiments, the system can store the responses for later retrieval by the user. The system can be designed to handle a variety of natural language queries and generate verified responses in a reliable and efficient manner.

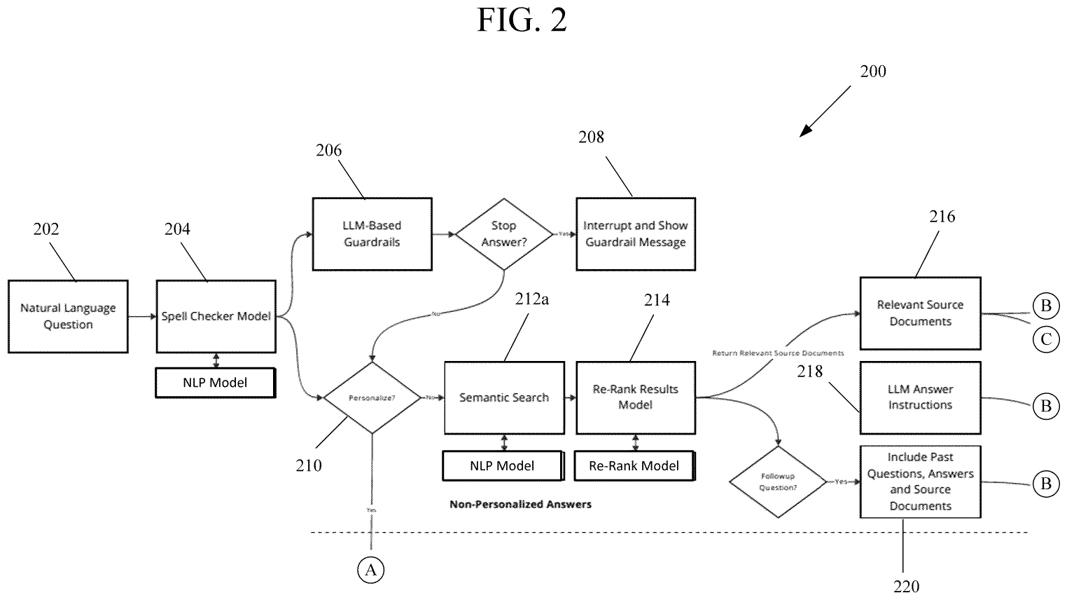

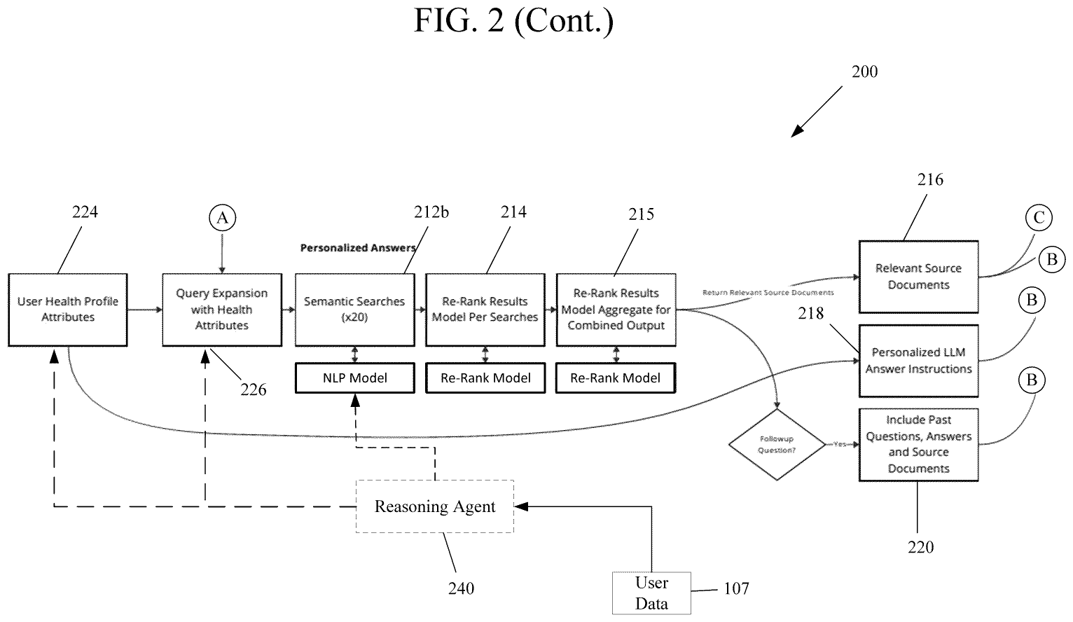

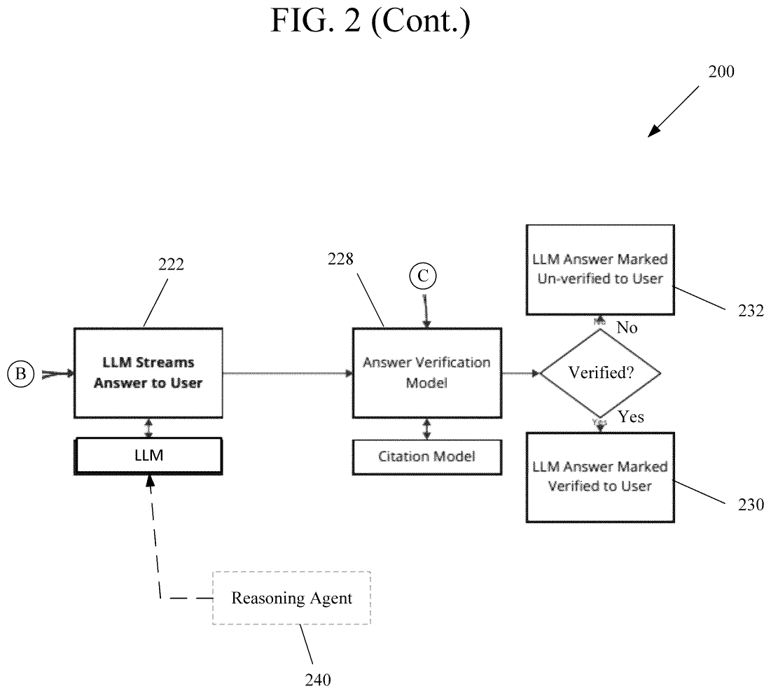

In one embodiment, the health information platform 100 can execute a process to access user data 107 associated with an account or profile for a user in order to personalize the responses and/or health content 106 provided in response to queries submitted by users. One embodiment of such a process 200 is shown in FIG. 2. In various embodiments, the process 200 can be embodied as software, hardware, firmware, and various combinations thereof. In various embodiments, the process 200 can be executed by and/or between a variety of different devices or systems. For example, various combinations of steps of the process 200 could be executed by the health information platform 100, the network 130, and/or the user device 120. In various embodiments, the system(s) executing the process 200 can utilize distributed processing, parallel processing, cloud processing, and/or edge computing techniques. For brevity, the process 200 is described below as being executed by the health information platform 100; however, it should be understood that the functions can be individually or collectively executed by one or multiple devices or systems described in connection with FIG. 1.

Accordingly, the health information platform 100 executing the process 200 can receive 202 a query from a user. The query can be related to or otherwise associated with health information that can be supplied by the health information platform 100, such as symptoms associated with asthma, how often individuals should have checkups with their doctors, diet recommendations for individuals with particular conditions, and so on. In one embodiment, the query can be in the form of a natural language question. In one embodiment, the received query can be processed through a spellchecker module 204 to correct any misspellings or typographical errors by the user in constructing his or her query. The spellchecker module 204 can be programmed or trained to recognize medical, anatomical, and biological terms, for example. The spellchecker module 204 could include an NLP module, for example.

Further, the health information platform 100 can process the received query through a guardrails module 206. The guardrails module 206 can analyze the content of the received query to determine whether it pertains to a list of topics that have been flagged by the operator of the health information platform 100. In one embodiment, the topics could include whether the indicating that they are suffering from a medical emergency, whether the user is exhibiting signs of self-harm, or whether the user is asking a non-health or medical topic. The guardrails module 206 can be useful to, for example, control the interactions between users and the health information platform 100. If the guardrails module 206 determines that the content of the received query pertains to one of the enumerated topics, the health information platform 100 can interrupt 208 the response generation workflow (described below) and provide the user with a cached message corresponding to the identified topic within the query flagged by the guardrails module 206. For example, if the guiderails module 206 determines that the query indicates that the user is having a medical emergency, the health information platform 100 can return a message telling the user to call 911 immediately. In one embodiment, the guardrails module 206 can include a large language model (LLM) for interpreting the received query. In one embodiment, the health information platform 100 can execute the guardrails module 206 in parallel with the response generation workflow.

Accordingly, the health information platform 100 determines 210 whether to provide a personalized response to the user in response to the received query. The health information platform 100 can determine 210 whether to provide a personalized response based on whether the user has created an account or otherwise the health information platform 100 otherwise has stored data for the user, the type of query submitted by the user (e.g., certain queries, such as “what is cardiovascular disease?”, may not necessitate a personalized response), and other factors. If the health information platform 100 determines 210 that a personalized response is not required, then the health information platform 100 can perform a semantic search 212a based on the user's query (e.g., using a NLP model) to obtain search results, re-rank 214 the search results using a re-rank model, retrieve 216 the relevant source documents associated with the search results, and provide 222 the answer to the user. In one embodiment, the answer provided 222 to the user can incorporate proprietary instructions 218 to tune the form and/or content of the answer provided 222 to the user. In one embodiment, the health information platform 100 can further incorporate 220 past questions, answers, and/or source documents into the answer provided 222 by the health information platform 100.

If the health information platform 100 determines 210 that a personalized response is required, the health information platform 100 can retrieve 224 the data 107 associated with the user (e.g., stored in the database 112) and perform a query expansion 226 based on the retrieve user data 107. In various embodiments, the health information platform 100 can expand the user's query into five or more, ten or more, twenty or more, or thirty or more queries that are tailored to the retrieved user data 224. Query expansion consists of taking an initial query and then generating additional queries therefrom based on additional data associated with the individual. For example, the query “should I get tested for hypertension?” submitted by a 56-year old male with a history of diabetes can get expanded into “should a male get tested for hypertension?,” should a male over the age of 55 get tested for hypertension?”, “should someone with a history of diabetes get tested for hypertension?”, and so on. Accordingly, the health information platform 100 can perform a series of semantic searches 212b for the expanded set of queries. The health information platform 100 can then re-rank 214 the search results (as described above) for each of the expanded queries and, further, re-rank 215 the aggregate search results. The health information platform 100 can re-rank 215 the aggregate search results using a re-rank model, as described above. Further, the health information platform 100 can retrieve 216 the relevant source documents associated with the search results and provide 222 the answer to the user as an aggregated health information response, similarly to as described above.

In one embodiment, the answer provided 222 to the user can further be analyzed by a verification model 228 that is trained to indicate to the user whether the answer is verified 230 or unverified 232. The verification model 228 can include a citation model that is trained to analyze whether the provided answer is supported by or based upon a sufficient number of sources (as retrieved 216 by the health information platform 100). In one embodiment, answer provided 222 to the user can be based on the source documents retrieved 216 by the health information platform 100. Accordingly, the verification model 228 can semantically compare the generated response with the source document(s) and measure similarity of the output and the source material based on one or more thresholds. For example, the verification model 228 could determine the similarity of a sentence in the answer to a corresponding sentence in a source material document and/or the percentage of sentences in the answer that are similar to a source material document. For example, if the citation model determines that the provided answer is not based upon at least a threshold number of citation sources, the citation model can determine that the provided answer should be marked as unverified. Based on the results of the analysis by the verification model 228, the health information platform 100 can display to the user that the answer is verified 230, along with the list of retrieved source documents that met the thresholds set by the verification model 228. Any sources that did not meet the thresholds set by the verification model 228 can be discarded and may not be shown in association with the provided answer. The verification model 228 can be beneficial because it can provide transparency to users as to how the health information platform 100 came to the provided answer (in combination with the citation sources provided to the user) and the relative degree of confidence that the user can have in the answer. By prompting transparency, the health information platform 100 can thereby increase user trust in the system, thereby promoting continued user of the health information platform 100. Further, this feature can allow the system to confirm whether the LLM used the source documents to generate the response to the user's query and, if so, which particular source documents were used.

In some embodiments, the health information platform 100 can further a reasoning agent 240 that operates as an integrated component within the overall system architecture to analyze user queries and health profile data. In some cases, the reasoning agent 240 may be implemented as a specialized module that processes natural language queries in conjunction with user-specific health characteristics to generate more targeted and relevant responses. The reasoning agent 240 can function as an intermediary processing layer that bridges the gap between raw user queries and the comprehensive health information database maintained by the health information platform 100.

The reasoning agent 240 can be based on advanced language model architectures, which provide sophisticated natural language understanding and reasoning capabilities. In some cases, the reasoning agent 240 can be configured to perform multiple analytical functions within the health information platform 100, including the prioritization of health profile characteristics that are most relevant to a given user query. The reasoning agent 240 can evaluate various elements of a user's health profile, such as age, biological sex, medical conditions, lifestyle factors, and other health-related attributes, to determine which characteristics can have the most substantial impact on the appropriate response to a particular query. This prioritization process can enable the health information platform 100 to focus computational resources on the most relevant aspects of a user's health profile rather than processing all available profile data uniformly.

The health information application 108 within the health information platform 100 can utilize the reasoning agent 240 to generate analytical thoughts regarding how specific profile characteristics can influence the answer to a user's health-related question. The reasoning agent 240 can create detailed assessments that explore the relationships between user health attributes and potential health information responses. In some cases, these analytical thoughts can include considerations of how certain medical conditions, demographic factors, or lifestyle choices can affect the relevance or applicability of different health information sources. The reasoning agent 240 can generate thoughts that encompass symptom presentations, disease risk factors, treatment considerations, and prognostic factors that can be particularly relevant to users with similar health profiles.

The reasoning agent 240 can further translate the generated analytical thoughts into semantic search terms that can be utilized by search algorithms within the health information platform 100. In some cases, the reasoning agent 240 can convert abstract relationships between health profile characteristics and query topics into specific search terminology that can effectively retrieve relevant health information from available databases and sources. The semantic search terms generated by the reasoning agent 240 can be designed to match the language and terminology commonly used in medical literature, health information sources, and clinical documentation. This translation process can enable the health information platform 100 to conduct more targeted searches that are specifically tailored to the user's health profile rather than relying solely on the original query terms provided by the user.

The integration of the reasoning agent 240 within the health information application 108 can enable a multi-step processing workflow that enhances the overall personalization capabilities of the health information platform 100. The reasoning agent 240 can operate in coordination with other system components to ensure that personalized responses are generated efficiently and accurately. In some cases, the reasoning agent 240 can process user queries in real-time, generating prioritized health characteristics, analytical thoughts, and semantic search terms within the time constraints required for responsive user interactions. The reasoning agent 240 can also be configured to adapt its processing approach based on the complexity of user queries, the comprehensiveness of available health profile data, and the specific health topics being addressed by users.

The reasoning agent 240 can be implemented using various artificial intelligence model architectures that provide natural language processing and analytical reasoning capabilities. In some cases, the reasoning agent 240 can be based on large language model architectures, such as ChatGPT 40, which offer sophisticated understanding of natural language queries and the ability to generate contextual responses based on complex input data. Large language models can provide the reasoning agent 240 with the computational foundation necessary to process user health profile information in conjunction with submitted queries to generate meaningful analytical insights. The implementation of large language models as the underlying architecture for the reasoning agent 240 can enable the processing of diverse health-related terminology, medical concepts, and user profile characteristics in a unified analytical framework.

Alternative artificial intelligence model implementations for the reasoning agent 240 can include transformer-based architectures, neural network models, or hybrid systems that combine multiple machine learning approaches. In some cases, the reasoning agent 240 can utilize pre-trained language models that have been fine-tuned on health-related datasets to enhance performance in medical and health information domains. The technical foundation of the reasoning agent 240 can incorporate attention mechanisms that allow the model to focus on relevant portions of user health profiles when analyzing specific query contexts. These attention mechanisms can enable the reasoning agent 240 to dynamically weight different health profile characteristics based on their relevance to particular types of health information requests.

The reasoning agent 240 implementation can incorporate multi-stage processing capabilities that enable the systematic analysis of user queries and health profile data. In some cases, the reasoning agent 240 can be configured to perform prioritization functions that evaluate health profile characteristics and determine which attributes can have the most substantial impact on appropriate responses to user queries. The prioritization process can involve analyzing relationships between demographic factors, medical conditions, lifestyle characteristics, and other health-related attributes to identify the most relevant profile elements for specific query contexts. The reasoning agent 240 can utilize scoring algorithms or ranking mechanisms to organize health profile characteristics in order of relevance to particular health information topics.

The analytical capabilities of the reasoning agent 240 can extend to the generation of detailed thoughts regarding how specific profile characteristics can influence health information responses. In some cases, the reasoning agent 240 can create comprehensive assessments that explore the connections between user health attributes and potential health outcomes, treatment considerations, or risk factors. The thought generation process can involve the synthesis of medical knowledge, epidemiological data, and clinical guidelines to produce insights that are specifically tailored to individual user profiles. The reasoning agent 240 can generate thoughts that encompass multiple dimensions of health information, including symptom presentations, disease progression patterns, treatment efficacy considerations, and preventive care recommendations that can be particularly applicable to users with similar health characteristics.

The translation of analytical thoughts into semantic search terms can represent another technical capability of the reasoning agent 240 implementation. In some cases, the reasoning agent 240 can convert abstract relationships and analytical insights into specific terminology that can be effectively utilized by search algorithms and information retrieval systems. The semantic search term generation process can involve the identification of medical terminology, clinical concepts, and health-related keywords that accurately represent the analytical thoughts produced by the reasoning agent 240. The reasoning agent 240 can be configured to generate multiple semantic search terms for each analytical thought, providing comprehensive coverage of relevant terminology that can be present in health information sources and medical literature.

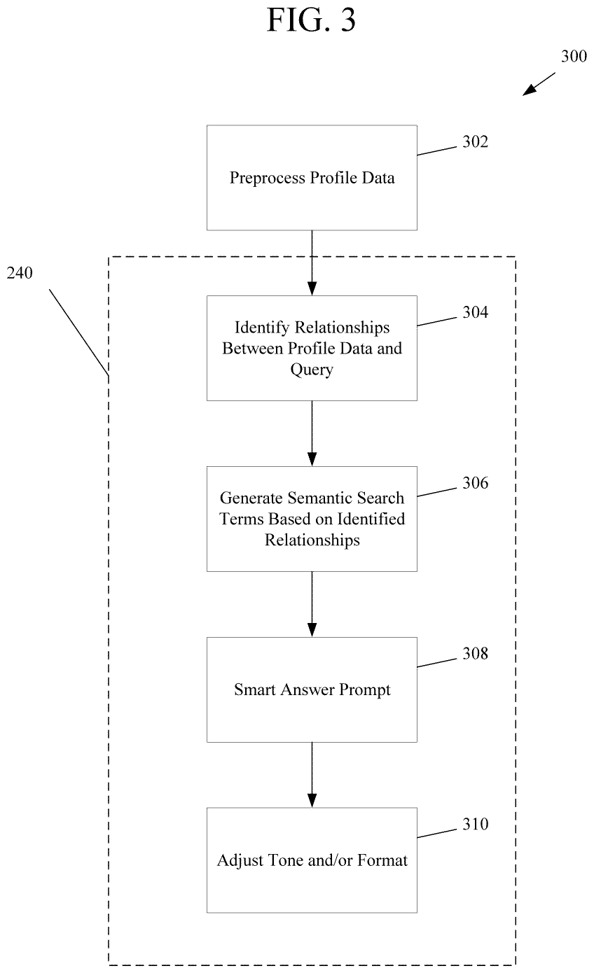

Referring back to FIG. 2, in some embodiments, the process 200 implemented by the health information platform 100 can further incorporate the reasoning agent 240 to systematically evaluate connections between user health characteristics and submitted queries. In conjunction with the process 200 shown in FIG. 2, FIG. 3 illustrates a process 300 specifically highlighting the steps performed using and by the reasoning agent 240. Accordingly, the processes 200, 300 shown in FIGS. 2 and 3 should be read and understood in tandem with each other.

As generally described above, the process 200 can retrieve 224 a user's profile to access stored user health data from the database system to obtain comprehensive information about the user's health profile. In some cases, the profile retrieval step 224 can extract various categories of health-related information, including demographic data, medical history, current health conditions, lifestyle factors, and other relevant health attributes that can influence the appropriateness of health information responses. The profile retrieval step 224 can be configured to access user profile data in real-time when queries are submitted, ensuring that the most current and complete health information is available for analysis by the reasoning agent 240. In one embodiment, the health information platform 100 can perform preprocessing 302 on the retrieved user profile data to make the searching and analysis steps more efficient and accurate. For example, the remove null fields from the user data or transform data formats (e.g., transform a birth date into a predefined number format, transform a birth year into a predefined age grouping, such as “teenager” or “older adult,” or transform a height and weight into body mass index).

The reasoning agent 240 can perform detailed analysis of user profile characteristics to determine the relevance and potential impact of each health attribute on the submitted query. In some cases, the reasoning agent 240 can evaluate demographic factors such as age, biological sex assigned at birth, and other biographical information to assess how these characteristics can influence health information needs and appropriate response content. The reasoning agent 240 can also analyze medical conditions, health history, and lifestyle factors to identify profile elements that can have substantial bearing on the user's health information query. The analysis process can involve the application of medical knowledge and clinical guidelines to determine which profile characteristics can be most relevant to specific types of health questions or symptom inquiries.

With continued reference to FIG. 2, the reasoning agent 240 can utilize advanced natural language processing capabilities to assess the semantic relationships between user profile elements and query content. The reasoning agent 240 can be based on ChatGPT 40 architecture, which can provide sophisticated analytical capabilities for understanding complex relationships between health profile characteristics and health information topics. In some cases, the reasoning agent 240 can generate prioritized assessments that rank health profile characteristics according to their potential impact on appropriate responses to user queries. The prioritization process can involve the evaluation of multiple profile elements simultaneously, considering how combinations of health characteristics can interact to influence the relevance of different health information sources and response content.

The user profile data can undergo streamlined transformation processes that optimize the format and presentation of health information for analysis by the reasoning agent 240. In some cases, the transformation process can include the removal of null fields from user profile data to eliminate incomplete or missing information that can not contribute to the analysis process. The transformation process can also involve the conversion of birth year information to numeric age values and corresponding age group terms, such as teenager, young adult, adult, or older adult categories, which can provide more meaningful demographic context for health information analysis. The transformation process can further include the conversion of height and weight measurements into body mass index categories, such as healthy weight, overweight, or obese classifications, which can be more relevant for health information personalization than raw measurement values.

Further, the reasoning agent 240 can identify 304 key relationships between the user profile data and the particular query, thereby determining specific profile characteristics can impact the answer to user queries and creating detailed assessments of the relationships between health attributes and potential response content. In some cases, the identification 304 of relationships can encompass considerations of disease risk factors, symptom presentations, treatment considerations, and prognostic factors that can be particularly relevant to users with similar health profile characteristics. The reasoning agent 240 can synthesize medical knowledge and clinical guidelines to produce thoughts that address multiple dimensions of health information, including how demographic factors, medical conditions, and lifestyle characteristics can influence the applicability and relevance of different health information sources. The thought generation process can involve the analysis of epidemiological data and clinical evidence to create insights that are specifically tailored to individual user health profiles.

The reasoning agent 240 can further generate 306 semantic search terms from the identified relationships that are designed to return specific source materials that will impact the final answer. In embodiments of the process 200 incorporating the reasoning agent, the query expansion step 226 can utilize the semantic search terms generated 306 by the reasoning agent 240 to create multiple variations of the original user query that incorporate relevant health profile characteristics. The query expansion step 226 can translate the abstract relationships identified by the reasoning agent 240 into specific search terms and query variations that can be effectively processed by semantic search algorithms. In some cases, the query expansion step 226 can generate numerous expanded queries that address different aspects of the relationship between the user's health profile and the submitted question. The expanded queries can incorporate medical terminology, demographic descriptors, and condition-specific language that reflects the analytical insights produced by the reasoning agent 240, enabling more targeted and comprehensive information retrieval processes.

The reasoning agent 240 can translate the generated analytical thoughts into semantic search terms that accurately represent the relationships between user health characteristics and query topics. In some cases, the translation process can involve the identification of medical terminology, clinical concepts, and health-related keywords that can effectively retrieve relevant information from health databases and medical literature sources. The semantic search terms can be designed to match the language and terminology commonly used in authoritative health information sources, ensuring that the search process can identify content that addresses the specific health profile considerations identified by the reasoning agent 240. The translation process can generate multiple semantic search terms for each analytical thought, providing comprehensive coverage of relevant terminology and concepts that can be present in available health information resources.

The reasoning agent 240 can perform comprehensive medical context exploration that encompasses multiple dimensions of health information analysis to generate detailed insights regarding the relationships between user health profiles and submitted queries. In some cases, the medical context exploration process can involve the systematic evaluation of symptom presentations, disease characteristics, treatment considerations, and prognostic factors that can be relevant to users with specific health profile attributes. The reasoning agent 240 can utilize advanced natural language processing capabilities to analyze complex medical relationships and generate analytical thoughts that address how various health profile characteristics can influence appropriate responses to health-related questions. The medical context exploration can incorporate clinical knowledge, epidemiological data, and evidence-based medical guidelines to produce comprehensive assessments that are tailored to individual user health characteristics.

The reasoning agent 240 can generate analytical thoughts that explore symptom presentations and manifestations that can be particularly relevant to users with specific demographic characteristics, medical conditions, or lifestyle factors. In some cases, the thought generation process can involve the analysis of how age, biological sex, body mass index categories, smoking status, and existing medical conditions can influence the likelihood, severity, or presentation patterns of various symptoms or health concerns. The reasoning agent 240 can synthesize medical knowledge to create thoughts that address how certain health profile characteristics can affect symptom recognition, differential diagnosis considerations, and the clinical significance of reported symptoms. The analytical thoughts can encompass considerations of how demographic factors can influence symptom presentation patterns, including variations in symptom severity, duration, or associated manifestations that can be more common in specific population groups.

The disease exploration capabilities of the reasoning agent 240 can encompass the analysis of risk factors, disease progression patterns, and condition-specific considerations that can be relevant to users with particular health profile characteristics. In some cases, the reasoning agent 240 can generate thoughts that explore how obesity, smoking history, age groups, and existing medical conditions can influence disease susceptibility, progression rates, or complication risks for various health conditions. The disease analysis process can involve the evaluation of epidemiological data and clinical evidence to identify relationships between user health attributes and disease characteristics that can be particularly applicable to individual health profiles. The reasoning agent 240 can create analytical thoughts that address how combinations of health profile characteristics can interact to influence disease risk, prognosis, or management considerations.

Treatment exploration performed by the reasoning agent 240 can involve the analysis of therapeutic considerations, intervention options, and management strategies that can be particularly relevant or appropriate for users with specific health profile characteristics. In some cases, the reasoning agent 240 can generate thoughts that explore how demographic factors, existing medical conditions, lifestyle characteristics, and other health attributes can influence treatment selection, dosing considerations, contraindications, or therapeutic effectiveness. The treatment analysis process can encompass considerations of how age groups, biological sex, body mass index categories, and comorbid conditions can affect medication metabolism, surgical candidacy, or response to various therapeutic interventions. The reasoning agent 240 can create analytical thoughts that address treatment modifications, monitoring requirements, or alternative therapeutic approaches that can be more appropriate for users with particular health profile combinations.

Prognostic analysis capabilities of the reasoning agent 240 can encompass the exploration of outcome predictions, recovery expectations, and long-term health considerations that can be influenced by user health profile characteristics. In some cases, the reasoning agent 240 can generate thoughts that explore how demographic factors, existing medical conditions, lifestyle choices, and other health attributes can affect disease outcomes, recovery timelines, or long-term health trajectories. The prognostic exploration process can involve the analysis of clinical studies, outcome data, and evidence-based prognostic factors to identify relationships between user health characteristics and expected health outcomes. The reasoning agent 240 can create analytical thoughts that address how specific health profile combinations can influence prognosis, including considerations of factors that can improve or worsen expected outcomes for particular health conditions or treatment approaches.

The medical context analysis performed by the reasoning agent 240 can incorporate multiple analytical frameworks that enable comprehensive evaluation of health information relationships across various medical domains. In some cases, the analysis process can utilize clinical decision-making frameworks, evidence-based medicine principles, and risk stratification methodologies to generate insights that are grounded in established medical knowledge and clinical practice guidelines. The reasoning agent 240 can apply differential diagnosis approaches, risk assessment algorithms, and clinical prediction models to create analytical thoughts that address the complex relationships between user health profiles and health information topics. The medical context analysis can encompass considerations of how multiple health profile characteristics can interact synergistically or antagonistically to influence health outcomes, treatment responses, or disease progression patterns.

The generation of analytical thoughts by the reasoning agent 240 can involve sophisticated natural language processing capabilities that enable the synthesis of medical knowledge with individual health profile characteristics to produce contextually relevant insights. In some cases, the thought generation process can utilize large language model architectures that provide advanced understanding of medical terminology, clinical concepts, and health-related relationships. The reasoning agent 240 can generate thoughts that encompass multiple perspectives on health information topics, including considerations of how different health profile characteristics can lead to varying clinical presentations, treatment approaches, or outcome expectations. The analytical thought generation can incorporate evidence-based medical knowledge, clinical guidelines, and epidemiological data to ensure that the insights produced are grounded in established medical understanding and clinical practice standards.

The reasoning agent 240 can identify specific source materials that will impact the final answer through a systematic translation process that converts analytical thoughts into targeted semantic search terms. In some cases, the reasoning agent 240 can analyze the generated thoughts regarding health profile characteristics and query relationships to extract key medical concepts, terminology, and contextual elements that can be effectively utilized for information retrieval. The identification process can involve the parsing of analytical thoughts to isolate specific medical terms, condition names, demographic descriptors, and clinical concepts that represent the core elements of the relationship between user health profiles and submitted queries. The reasoning agent 240 can utilize natural language processing capabilities to recognize medical terminology within the analytical thoughts and convert these terms into search queries that can effectively retrieve relevant health information from available databases and literature sources.

The translation of analytical thoughts into semantic search terms can represent a technical process that bridges the gap between abstract health profile analysis and concrete information retrieval operations. The reasoning agent 240 can process the detailed assessments generated during the thought creation phase to identify specific terminology and concepts that can be formulated into effective search queries. In some cases, the translation process can involve the extraction of medical terminology, clinical descriptors, demographic identifiers, and condition-specific language from the analytical thoughts to create search terms that accurately represent the health profile considerations identified by the reasoning agent 240. The semantic search term generation can encompass multiple categories of health-related terminology, including symptom descriptors, disease names, treatment terminology, demographic classifications, and risk factor identifiers that reflect the comprehensive analysis performed by the reasoning agent 240.

The reasoning agent 240 can generate semantic search terms that are specifically designed to match the language and terminology commonly utilized in medical literature, clinical guidelines, and authoritative health information sources. In some cases, the semantic search term generation process can involve the analysis of medical vocabulary, clinical terminology standards, and health information database structures to ensure that the generated search terms can effectively identify relevant content within available information repositories. The reasoning agent 240 can create multiple variations of semantic search terms for each analytical thought, providing comprehensive coverage of relevant terminology that can be present in different health information sources. The semantic search terms can incorporate synonyms, alternative terminology, and related concepts to maximize the likelihood of retrieving comprehensive and relevant health information that addresses the specific profile considerations identified during the analytical thought generation process.

In embodiments of the process 200 incorporating the reasoning agent 240, the enhanced search process can utilize the semantic search terms generated by the reasoning agent 240 to conduct multiple targeted information retrieval operations that are specifically tailored to user health profile characteristics. As described above, the semantic search step 212b can implement the enhanced search methodology by performing numerous individual searches based on the profile-specific search queries derived from the reasoning agent 240 thoughts. In some cases, the semantic search step 212b can several (e.g., 10, 20, or 100 or more) individual semantic searches, with each search operation targeting specific aspects of the relationship between user health profiles and submitted queries. The enhanced search approach can enable comprehensive information retrieval that addresses multiple dimensions of health information relevance, including demographic considerations, condition-specific factors, lifestyle influences, and other health profile characteristics that can impact appropriate response content.

The semantic search step 212b can execute profile-specific search queries that combine the original user query with the semantic search terms generated by the reasoning agent 240 to create targeted search operations. In some cases, each individual search within the semantic search step 212b can focus on specific health profile characteristics or combinations of characteristics that were identified as relevant during the reasoning agent 240 analysis process. The search queries can incorporate medical terminology, demographic descriptors, condition names, and other health-related concepts that reflect the analytical insights produced by the reasoning agent 240. The semantic search step 212b can utilize advanced search algorithms and natural language processing techniques to identify health information sources that address the specific profile considerations represented by each search query, enabling the retrieval of content that is particularly relevant to users with similar health characteristics.

The enhanced search process implemented through the semantic search step 212b can generate comprehensive search results that encompass multiple perspectives on health information topics based on different aspects of user health profiles. In some cases, the multiple search operations can retrieve information sources that address various dimensions of health information relevance, including age-specific considerations, gender-related factors, condition-specific guidance, lifestyle-related recommendations, and other profile-based health information elements. The semantic search step 212b can collect search results from each individual search operation and compile these results into a comprehensive set of source materials that reflect the diverse health profile considerations identified by the reasoning agent 240. The enhanced search methodology can enable the identification of source materials that might not be retrieved through traditional search approaches that rely solely on original query terms without consideration of user health profile characteristics.

In these embodiments, the semantic search step 212b can implement sophisticated search algorithms that can effectively process the profile-specific search queries generated from reasoning agent 240 thoughts to identify relevant health information sources. The search algorithms can utilize semantic matching techniques, natural language processing capabilities, and medical terminology recognition systems to identify content that addresses the specific health profile considerations represented in each search query. In some cases, the semantic search step 212b can access multiple health information databases, medical literature repositories, clinical guideline collections, and other authoritative health information sources to ensure comprehensive coverage of available relevant content. The search process can incorporate relevance scoring mechanisms that evaluate the degree to which identified sources address the specific health profile characteristics and query topics represented in each search operation.

The source material identification process can involve the systematic evaluation of search results to determine which sources provide the most relevant and comprehensive information for addressing user queries in the context of specific health profile characteristics. In some cases, the reasoning agent 240 can analyze the content and relevance of identified source materials to assess how effectively each source addresses the health profile considerations that were identified during the analytical thought generation process. The source evaluation can encompass considerations of content quality, medical accuracy, relevance to specific demographic groups, applicability to particular health conditions, and alignment with the analytical insights produced by the reasoning agent 240. The identification process can prioritize source materials that provide comprehensive coverage of the health profile characteristics that were determined to have substantial impact on appropriate responses to user queries.

The enhanced search methodology can enable the health information platform 100 to access a broader range of relevant health information sources than would be available through conventional search approaches that do not incorporate health profile considerations. In some cases, the profile-specific search queries generated by the reasoning agent 240 can identify specialized health information sources that address particular demographic groups, specific medical conditions, or unique combinations of health characteristics that are relevant to individual users. The enhanced search process can retrieve information from clinical studies, medical guidelines, health organization recommendations, and other authoritative sources that provide targeted guidance for users with specific health profile attributes. The comprehensive source identification enabled by the enhanced search methodology can contribute to the generation of more accurate, relevant, and personalized health information responses that address the specific needs and characteristics of individual users.

The reasoning agent 240 implementation can enable substantial improvements in the quality and relevance of health information responses generated by the health information platform 100. The enhanced processing capabilities provided by the reasoning agent 240 can result in more comprehensive, accurate, and contextually appropriate answers that address the specific health profile characteristics of individual users. In some cases, the reasoning agent 240 can contribute to improved answer quality by ensuring that responses incorporate relevant medical knowledge, clinical considerations, and evidence-based information that is specifically applicable to users with particular demographic attributes, medical conditions, and lifestyle factors. The reasoning agent 240 can enhance the overall effectiveness of the health information platform 100 by generating responses that are more closely aligned with individual user needs and health circumstances than would be possible through conventional query processing approaches that do not incorporate detailed health profile analysis.

The implementation of the reasoning agent 240 within the health information application 108 can result in enhanced answer relevance through the systematic incorporation of user-specific health characteristics into the response generation process. In some cases, the reasoning agent 240 can improve the relevance of health information responses by ensuring that answers address the particular health profile elements that are most applicable to individual users, such as age-related considerations, gender-specific factors, condition-related guidance, and lifestyle-influenced recommendations. The reasoning agent 240 can contribute to improved response relevance by generating analytical thoughts that explore how specific health profile characteristics can influence symptom presentations, disease risk factors, treatment considerations, and prognostic factors that are particularly applicable to users with similar health attributes. The enhanced relevance achieved through reasoning agent 240 implementation can enable users to receive health information that is more directly applicable to their individual health circumstances and more actionable for their specific health management needs.

With continued reference to FIG. 2, the reasoning agent 240 can contribute to enhanced personalization capabilities that enable the health information platform 100 to generate responses that are specifically tailored to individual user health profiles rather than providing generic health information that can not address user-specific considerations. The personalization improvements achieved through reasoning agent 240 implementation can encompass multiple dimensions of health information customization, including demographic-specific guidance, condition-tailored recommendations, lifestyle-appropriate suggestions, and risk-factor-informed advice that reflects the comprehensive analysis of user health characteristics performed by the reasoning agent 240. In some cases, the enhanced personalization can result in responses that address multiple aspects of user health profiles simultaneously, creating comprehensive answers that consider how combinations of health characteristics can interact to influence appropriate health information guidance and recommendations.

The reasoning agent 240 can enable the generation of more comprehensive health information responses through the systematic exploration of multiple health profile dimensions and the incorporation of diverse medical perspectives that address various aspects of user health characteristics. In some cases, the comprehensive nature of responses generated through reasoning agent 240 implementation can encompass considerations of symptom presentations, disease characteristics, treatment options, prognostic factors, and preventive care recommendations that are specifically relevant to users with particular health profile attributes. The reasoning agent 240 can contribute to response comprehensiveness by generating analytical thoughts that explore multiple medical domains and clinical considerations, ensuring that answers address various aspects of health information topics that can be relevant to individual users. The enhanced comprehensiveness achieved through reasoning agent 240 implementation can provide users with more complete and informative responses that address multiple facets of their health information needs within a single interaction with the health information platform 100.

In some embodiments, the reasoning agent 240 can incorporate a smart answer prompt 308 that includes multiple answer guideline instructions and conditional answer guideline instructions for generating personalized responses. In some cases, the smart answer prompt 308 can make use of answer guideline instructions and conditional answer guideline instructions that provide detailed guidance for formulating responses based on user health profile characteristics and query content. The smart answer prompt 308 can be utilized in conjunction with the outputs of the semantic search step 212b and the query expansion step 226 to ensure that generated responses incorporate relevant health information while adhering to specific formatting and content guidelines.

The smart answer prompt 308 can enable the health information platform 100 to implement person-first language guidelines in generated responses. In some cases, the answer guideline instructions can specify language conventions that prioritize the individual rather than their health conditions or characteristics. The smart answer prompt 308 can guide the response generation process to use terminology such as “a person with obesity” rather than “an obese person” to emphasize the user's identity beyond their health condition. This approach can contribute to more respectful and empathetic communication of health information that aligns with current best practices in healthcare communication.

In some embodiments, the reasoning agent 240 can implement guidelines (i.e., instructions and/or rules) to adjust 310 the tone and/or format of the smart answer prompt 308. The guidelines for tone could include always using person-first language, avoiding addressing the user, and/or using language that is supportive and empathetic. For example, the answer guidelines can include instructions for avoiding direct addressing of users with second-person pronouns in generated responses. In some cases, the answer guideline instructions can specify the use of neutral, descriptive language rather than phrases such as “you are” or “your condition” when discussing user health characteristics. The smart answer prompt 308 can guide the response generation process to use alternative phrasing such as “for people with similar profiles” or “individuals with these health characteristics” to maintain a professional and objective tone in health information responses.

Accordingly, the health information platform 100 can utilize the smart answer prompt 308 to ensure the use of supportive, empathetic, and judgment-free language in generated responses. In some cases, the answer guideline instructions can specify language conventions that convey health information in a compassionate manner without imposing value judgments on user health characteristics or behaviors. The smart answer prompt 308 can guide the response generation process to use phrasing that acknowledges the challenges of various health conditions while providing constructive and encouraging information about management strategies and treatment options.

As noted above, the health information platform 100 can provide 222 comprehensive, personalized health information responses to users. In embodiments incorporating the reasoning agent 240, the provided answers can incorporate detailed explanations of health concepts, treatment options, and personalized recommendations based on user health profile characteristics, providing additional context, examples, and clarifications that enhance the overall informativeness and utility of the generated responses. The implementation of the reasoning agent 240 and associated enhancements within the health information platform 100 can result in significant improvements in the quality and relevance of health information responses provided to users. The combination of personalized query expansion, comprehensive semantic searching, and smart answer prompts 308 based on relevant user health data can enable the generation of responses that are tailored to individual user health profiles while maintaining high standards of accuracy, clarity, and empathetic communication. These enhancements can contribute to a more informative and supportive user experience within the health information platform 100, potentially improving health literacy and facilitating more informed decision-making regarding personal health management.

It should further be noted that although the functions and/or steps of the process 200 are depicted in a particular order or arrangement, the depicted order and/or arrangement of steps and/or functions is simply provided for illustrative purposes. Unless explicitly described herein to the contrary, the various steps and/or functions of the process 200 can be performed in different orders, in parallel with each other, in an interleaved manner, and so on.

While various embodiments have been described above, it should be understood that they have been presented by way of example and not limitation. It will be apparent to persons skilled in the relevant.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments can be used, and other changes can be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Instead, this application is intended to cover any variations, uses, or adaptations of the present teachings and use its general principles. Further, this application is intended to cover such departures from the present disclosure as come within known or customary practice in the art to which these teachings pertain. Many modifications and variations can be made to the particular embodiments described without departing from the spirit and scope of the present disclosure as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

Various of the above-disclosed and other features and functions, or alternatives thereof, can be combined into many other different systems or applications. Various presently unforeseen or unanticipated alternatives, modifications, variations or improvements therein can be subsequently made by those skilled in the art, each of which is also intended to be encompassed by the disclosed embodiments.

As used in this document, the singular forms “a,” “an,” and “the” include plural references unless the context clearly dictates otherwise. With respect to the use of substantially any plural and/or singular terms herein, those having skill in the art can translate from the plural to the singular and/or from the singular to the plural as is appropriate to the context and/or application. The various singular/plural permutations can be expressly set forth herein for sake of clarity.

As will be understood by one skilled in the art, for any and all purposes, such as in terms of providing a written description, all ranges disclosed herein are intended as encompassing each intervening value between the upper and lower limit of that range and any other stated or intervening value in that stated range. All ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells as well as the range of values greater than or equal to 1 cell and less than or equal to 3 cells. Similarly, a group having 1-5 cells refers to groups having 1, 2, 3, 4, or 5 cells, as well as the range of values greater than or equal to 1 cell and less than or equal to 5 cells, and so forth.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

By hereby reserving the right to proviso out or exclude any individual members of any such group, including any sub-ranges or combinations of sub-ranges within the group, that can be claimed according to a range or in any similar manner, less than the full measure of this disclosure can be claimed for any reason. Further, by hereby reserving the right to proviso out or exclude any individual substituents, structures, or groups thereof, or any members of a claimed group, less than the full measure of this disclosure can be claimed for any reason.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., +10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art. Where the context of the disclosure indicates otherwise, or is inconsistent with such an interpretation, the above-stated interpretation can be modified as would be readily apparent to a person skilled in the art. For example, in a list of numerical values such as “about 49, about 50, about 55, about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). Further, the transitional term “comprising,” which is synonymous with “including,” “containing,” or “characterized by,” is inclusive or open-ended and does not exclude additional, unrecited elements or method steps. While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention.

The term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine.

Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

Throughout this disclosure, various patents, patent applications and publications can be referenced. The disclosures of these patents, patent applications and publications are incorporated into this disclosure by reference in their entireties in order to more fully describe the state of the art as known to those skilled therein as of the date of this disclosure. This disclosure will govern in the instance that there is any inconsistency between the patents, patent applications and publications cited and this disclosure.

1. A computer-implemented method for personalizing health information content provided to a user, the method comprising:
receiving, by a computer system, a query from the user, the query associated with health information;
receiving, by the computer system, user profile data associated with the user, the user profile data comprising health data of the user and application use data by the user;
expanding, by the computer system, the query into a plurality of queries based on the health data of the user;
performing, by the computer system, semantic searches for the plurality of queries;
ranking, by the computer system, results from the performed semantic searches;
aggregating, by the computer system, the results from the performed semantic searches based on the ranking to generate an aggregated health information response; and
providing, by the computer system, the aggregated health information response to the user.

2. The computer-implemented method of claim 1, further comprising:
determining, by the computer system, whether the query contains guardrail content; and
based on whether the query contains the guardrail content, providing, by the computer system, a cached response to the query.

3. The computer-implemented method of claim 1, further comprising:
retrieving, by the computer system, source materials associated with the results from the performed semantic searches; and
providing, by the computer system, citations to the retrieved source materials to the user in connection with the provided aggregated health information response.

4. The computer-implemented method of claim 3, further comprising:
verifying, by the computer system, the aggregated health information response based on the retrieved source materials; and
providing, by the computer system, an indication as to whether the aggregated health information response is verified or unverified based on the verification.

5. The computer-implemented method of claim 1, wherein the aggregated health information response is provided via a large language model.

6. The computer-implemented method of claim 1, wherein the health data comprises biographic information and a medical history of the user.

7. A computer system for personalizing health information content provided to a user, the computer system comprising:
a processor; and
a memory coupled to the processor, the memory storing instructions that, when executed by the processor, cause the computer system to:
receive a query from the user, the query associated with health information;
receive user profile data associated with the user, the user profile data comprising health data of the user and application use data by the user;
expand the query into a plurality of queries based on the health data of the user;
perform semantic searches for the plurality of queries;
rank results from the performed semantic searches;
aggregate the results from the performed semantic searches based on the ranking to generate an aggregated health information response; and
provide the aggregated health information response to the user.

8. The computer system of claim 7, wherein the memory stores further instructions that, when executed by the processor, cause the computer system to:
determine whether the query contains guardrail content; and
based on whether the query contains the guardrail content, provide a cached response to the query.

9. The computer system of claim 7, wherein the memory stores further instructions that, when executed by the processor, cause the computer system to:
retrieve source materials associated with the results from the performed semantic searches; and
provide citations to the retrieved source materials to the user in connection with the provided aggregated health information response.

10. The computer system of claim 9, wherein the memory stores further instructions that, when executed by the processor, cause the computer system to:
verify the aggregated health information response based on the retrieved source materials; and
provide an indication as to whether the aggregated health information response is verified or unverified based on the verification.

11. The computer system of claim 7, wherein the aggregated health information response is provided via a large language model.

12. The computer system of claim 7, wherein the health data comprises biographic information and a medical history of the user.
